(19) United States
(12) Patent Application Publication
(10) Pub. No.: US 2026/0369002 A1
(43) Pub. Date: Nov. 19, 2026

(54) LEVEL-OF-DETAIL THREE-DIMENSIONAL SCENE GENERATION

(71) Applicant: GOOGLE LLC, Mountain View, CA (US)

(72) Inventors: Marie-Julie Rakotosaona, Zurich (CH); Fabian Manhardt, Munich (DE); Michael Niemeyer, Zurich (CH); Christina Nektaria Tsalicoglou, Zurich (CH); Federico Tombari, Zug (CH); Jonáš Kulhánek, Snežné (CZ); Songyou Peng, San Francisco, CA (US)

(21) Appl. No.: 19/678,888

(22) Filed: May 15, 2026

Related U.S. Application Data
(60) Provisional application No. 63/807,371, filed on May 16, 2025.

(51) Int. Cl. G06T 15/20

(52) U.S. Cl. CPC G06T 15/20; G06T 2210/36

(57) ABSTRACT

According to at least one implementation, a method can include determining a first set of shapes for a first region associated with a capture location, the first set of shapes having a first density. A second set of shapes may be determined for a second region outside of the first region, the second set of shapes having a second density. An image can then be rendered based on the first and second sets of shapes.

### CROSS-REFERENCE TO RELATED APPLICATION

This application claims priority to U.S. Provisional Patent Application No. 63/807,371, filed on May 16, 2025, the disclosure of which is incorporated by reference herein in its entirety.

### BACKGROUND

Three-dimensional (3D) scene generation from images involves the creation of realistic digital models using one or more two-dimensional pictures as a source. By analyzing these images to interpret shape, depth, and spatial layout, computing systems can reconstruct a 3D representation that is viewable from various angles. This process can involve detecting key features in images, estimating depth, and reconstructing surfaces to form a cohesive environment. In modern computer graphics and virtual reality applications, this technique is essential for transforming static photos or videos into interactive environments, such as a digital reconstruction of a room that a user can navigate and view from various perspectives.

The practical utility of 3D scene generation lies in its ability to facilitate novel view synthesis, a central area of research in computer vision. This technology powers a wide range of applications, including gaming, interactive maps, and extended reality (XR). In some implementations, the system populates a 3D space with primitives (i.e., shapes), such as colored blobs or semi-transparent points known as Gaussians, each with attributes such as position, size, and color. When these primitives are blended through a process called splatting, they produce images from different camera angles.

### SUMMARY

This disclosure relates to a system for displaying high-quality digital 3D environments on devices with limited processing power, such as smartphones or wearable headsets. A digital scene can be created by placing a vast number of small, semi-transparent colored shapes in a 3D space. To ensure the scene runs smoothly without exhausting memory resources or causing lag, the system adjusts the level of detail based on where a user is looking. Areas close to the user are rendered using many tiny shapes to show fine textures and sharp edges, while distant areas use fewer, larger shapes to save computer resources. For example, if a user explores a digital version of a historic library, the books on the shelf directly in front of the user appear in detail. Meanwhile, the bookshelves on the far side of the room are simplified to keep the device running efficiently. As the user walks across the room, the system gradually sharpens distant objects and simplifies those left behind, ensuring a fluid and realistic experience without sudden visual jumps.

In some implementations, the systems and methods can create a digital model by analyzing images to place a collection of shapes, such as Gaussians, in a 3D space. These shapes can include semi-transparent 3D points with attributes such as color, size, and position. When these shapes are blended through a process called splatting, the system can produce a realistic image of an environment from any perspective.

To ensure the scene can be rendered quickly on various devices, the system organizes the model into multiple levels of detail based on distance. A first set of shapes with a high density (i.e., quantity per volume) is determined for regions close to the camera to capture fine details. For regions further away, the system determines additional sets of shapes with a lower density. This reduction in density can be achieved by applying a smoothing filter that identifies redundant shapes, which are then pruned. As a user moves through the scene, the system can use an opacity blending scheme to smoothly transition between these sets of shapes, preventing visual artifacts like popping while maintaining high visual quality.

In some aspects, the techniques described herein relate to a method including: determining a first set of shapes for a first region associated with a capture location in a three-dimensional scene, the first set of shapes having a first density; determining a second set of shapes for a second region outside of the first region, the second set of shapes having a second density; and rendering an image based on the first set of shapes and the second set of shapes.

In some aspects, the techniques described herein relate to a computer-readable storage medium having program instructions stored thereon that, when executed by at least one processor, direct the at least one processor to perform a method, the method including: determining a first set of shapes for a first region associated with a capture location in a three-dimensional scene, the first set of shapes having a first density; determining a second set of shapes for a second region outside of the first region, the second set of shapes having a second density; and rendering an image based on the first set of shapes and the second set of shapes.

In some aspects, the techniques described herein relate to a computing system including: a computer-readable storage medium; at least one processor operatively coupled to the computer-readable storage medium; and program instructions stored on the computer-readable storage medium that, when executed by the at least one processor, direct the computing system to perform a method, the method including: determining a first set of shapes for a first region associated with a capture location in a three-dimensional scene, the first set of shapes having a first density; determining a second set of shapes for a second region outside of the first region, the second set of shapes having a second density; and rendering an image based on the first set of shapes and the second set of shapes.

The accompanying drawings and the description below outline the details of one or more implementations. Other features will be apparent from the description, drawings, and claims.

### BRIEF DESCRIPTION OF THE DRAWINGS

FIG. 1A illustrates an example of providing different levels of detail to a user according to an implementation.

FIG. 1B illustrates an operational scenario of rendering an image of a scene according to an implementation.

FIG. 2 illustrates a method of rendering an image of a scene according to an implementation.

FIG. 3 illustrates an operational scenario of rendering a scene from multiple images according to an implementation.

FIG. 4 illustrates an operational scenario of generating different levels of detail for different regions according to an implementation.

FIG. 5 illustrates a method of generating different levels of detail for a scene according to an implementation.

FIG. 6 illustrates an operational scenario of performing blending between regions according to an implementation.

FIG. 7 illustrates a computing system to display a 3D scene according to an implementation.

### DETAILED DESCRIPTION

Systems and methods can be configured to generate a level-of-detail representation of a scene using subsets of shapes selected based on distance from a capture location or position. In many digital applications, like exploring a virtual museum or viewing a 3D map of a city, a device may not have enough memory to show every single detail of a massive area at once. To solve this, the system breaks the environment into regions and assigns multiple levels of detail to each. When a user stands in a specific spot, the system identifies which regions are nearby and which are far away. The nearby regions are shown with the highest level of detail, using a dense collection of shapes to represent intricate features like the texture of a painting or the carving on a statue. Faraway regions are shown with a lower level of detail, using a smaller number of shapes to represent the general form of buildings or landscapes. As the user moves through the 3D space, the system smoothly blends these levels. This ensures that the view always looks clear and realistic where the user is looking, while the device handles the data efficiently. This approach allows a mobile device to display complex, large-scale environments that would otherwise be too complex to load.

In some implementations, a shape may comprise a discrete geometric primitive or volumetric data element defined by a set of spatial and visual attributes, such as a mathematical center, a boundary defined by a covariance matrix or dimensions, and/or an opacity value. These shapes may represent local samples of a surface or volume within a three-dimensional coordinate system and can be used to render the 3D scene by projecting the shapes onto a two-dimensional image plane. Through a process of blending the projected shapes, the system can produce a realistic representation of the environment from various perspectives. The system may construct the representation by generating the scene at different levels of detail, using a set of shapes with a high number per unit volume for regions near the capture location. As the distance increases, lower detail sets of shapes may represent faraway regions. To achieve this, a smoothing filter can be applied to the shapes to identify redundant primitives at greater distances. The density of the shapes can then be reduced by pruning or consolidating elements that contribute little to the rendered image, ensuring a lower quantity per unit volume in distant areas. This configuration may allow the scene to be rendered more efficiently on devices with limited memory while maintaining visual quality.

Standard 3D scene generation typically relies on the placement of primitives to represent the environment, which are then processed to produce an image from a specific viewpoint. In some systems, this involves using a 3D mesh, where a collection of vertices, edges, and faces defines the geometric structure and surfaces of objects. Alternatively, systems may utilize splatting or Gaussian Splatting, which populates a space with shapes, such as Gaussians, which are semi-transparent, colored 3D points that possess specific attributes like position, size, and opacity. While these methods can produce highly realistic models, rendering them on devices with limited memory presents a significant technical problem. For large-scale scenes, the number of primitives, whether mesh elements or Gaussians, required to capture fine details can exceed the device's GPU memory, preventing real-time rendering or causing substantial latency. Furthermore, traditional techniques often process dense data for distant regions that contribute little to the final image, leading to computational inefficiencies.

In some technical solutions, the system can be configured to use a level-of-detail (LOD) representation that adjusts the complexity of a 3D scene based on the distance from the camera. To achieve this, the system determines a first set of shapes for a first region located near the camera, which contains a high quantity of shapes per volume (i.e., density) to capture fine details. For regions further away, the system determines a second set of shapes for a second region with a lower quantity per volume. This can be done using a smoothing filter that identifies redundant shapes at a distance, allowing the system to prune or consolidate them. As used herein, the term region can be defined as a volumetric subdivision of a digital environment that possesses a unique identifier and is associated with multiple pre-computed sets of shapes at varying levels of detail. By reducing the number of active shapes in distant areas, the system provides the technical effect of ensuring that the model can be rendered quickly and fits within the limited memory of user devices, such as smartphones or wearables, without losing visual quality.

As used herein, the term quantity per volume (also referred to as population density or density) refers to a spatial density metric representing the local concentration of shapes within a region of three-dimensional space. This metric can be determined by the number of discrete shapes assigned to a specific spatial region divided by the total three-dimensional volume of that spatial region. A reduction in quantity per volume may represent a decrease in the population density of rendering primitives, wherein the quantity per volume can be adjusted based on a sampling interval required to satisfy a visual fidelity threshold at a specific distance from a capture location. A capture location can be defined as a point in a three-dimensional coordinate system that represents the perspective from which a scene is to be rendered.

For example, when a user navigates a digital reconstruction of a large room, the system identifies the user's current capture location and loads a dense set of Gaussians (semi-transparent 3D points) for the objects directly in front of them. For the far corners of the room, the system selects a separate set of Gaussians that has been simplified to contain fewer points. As the user moves toward a new area, the system can use an opacity blending scheme to smoothly transition between these sets of shapes. This prevents visual artifacts or popping and allows the device to keep the necessary sets of shapes in its memory at any given time.

In some implementations, a system can be configured to generate a representation of a scene using a set of shapes. The initial scene can be created by analyzing multiple input images to estimate the camera's position and the depth of objects. This data allows the system to place a large number of 3D points in space where surfaces likely exist. Each point is then converted into a primitive shape, such as a Gaussian, which is a semi-transparent, colored 3D point. For example, to reconstruct a digital version of a large room, the system may initially generate millions of these Gaussians to capture fine detail, from the texture of the walls to the edges of the furniture. Each Gaussian is assigned specific attributes, including its position, size, color, and opacity.

To manage this complexity efficiently, the system performs a series of pre-processing steps to separate the scene into a hierarchical LOD representation before rendering begins. This ensures the user device does not have to perform heavy calculations for each rendered frame. During this pre-processing operation, the system can be configured to divide the entire scene into manageable spatial chunks or regions. In some examples, this division can be achieved through K-means clustering, an algorithm that groups data points. In the example of the large room, the various camera positions used to capture the room are divided into distinct neighborhoods or clusters based on their location. Each chunk then acts as a local container for a specific set of shapes.

Within these chunks, the different levels of detail are determined by establishing distance thresholds. The system calculates how shapes should look when viewed from far away versus up close. To create a lower-detail level, the system can be configured to apply a 3D smoothing filter to the original, dense set of shapes. This filter can be based on a mathematical principle called Nyquist's theorem, which helps the system identify which shapes are too small to be rendered clearly at a certain distance. If a shape is smaller than the sampling interval of the pixels on the screen, the shape is considered redundant because the shape would only cause visual glitches or aliasing. Once these redundant shapes are identified, the system can be configured to use importance pruning to remove them. This process can reduce the number of shapes per unit volume, or the density, at that specific level of detail.

When a request to generate an image is received, these shapes are combined using a process called splatting. The system projects the 3D shapes onto a 2D plane, the user's screen, and blends them based on their color and transparency, or opacity. To ensure the transition between different parts of a large room is seamless, the system identifies two or more chunks closest to the user's current position and combines their active shapes. For example, if a user is walking across a massive hall, the system will use a high-density set of shapes for the furniture nearby while simultaneously loading a lower-density set for the distant corners. To prevent objects from suddenly popping into view as the user moves, the system employs an opacity blending scheme. This technique can gradually adjust the transparency of the shapes as the user crosses from one chunk or region to another, smoothly fading the different levels of detail together so the environment remains visually consistent and realistic.

As an illustrative example of the operations described herein, a system comprising one or more computers can be configured to generate a 3D representation of a ballroom by analyzing multiple images to estimate camera positions and the depths of various surfaces. This process allows the system to place a dense collection of initial Gaussians in the 3D space where surfaces likely exist. These Gaussians function as colored, semi-transparent primitives defined by attributes such as position, color, size, and opacity. During rendering, these shapes are projected onto a 2D screen and blended through a splatting process to form a cohesive image.

To organize a large environment, such as a ballroom, the system can divide the 3D space into smaller sections, called spatial chunks or regions. This process may involve a technique known as K-means clustering, a mathematical method used to group data into a specified number of distinct categories. In the context of this invention, K-means clustering can be employed to group various data points, such as the camera positions from the original photographs of the ballroom, based on their proximity to a central point, called a centroid. While the original camera positions can serve as the basis for these clusters to identify the most important areas of the room, the system may also use other positions, such as synthetic viewpoints or random camera orientations, to ensure the chunks effectively cover the entire environment.

In some implementations, the process begins by randomly or pseudo-randomly assigning a set number of centroids within the 3D space. Each data point, such as a specific camera coordinate, is then assigned to the nearest centroid, forming an initial group. After these assignments, the system calculates the average position of all points within each group to determine a new, more accurate center for the cluster. The centroids move to these new average positions, and the points are reassigned based on the updated locations. This cycle repeats until the centroids no longer move significantly, ensuring that each data point is assigned to the most appropriate neighborhood.

For example, if a system is reconstructing a digital model of a large ballroom, K-means clustering can be used to partition the expansive area into smaller sections such as “the dance floor,” “the tables,” and “the buffet.” Instead of processing the entire park at once, the system identifies the cluster of camera positions nearest to a specific centroid. This allows the device to focus its memory on the Gaussians or shapes assigned to that specific chunk.

Once these chunks are established, the system can create multiple levels of detail for each one. To generate a lower-detail version of a chunk, a 3D smoothing filter can be applied to the initial set of Gaussians. This filter helps identify shapes that are redundant or too small to be seen clearly from a distance. These unnecessary shapes can then be removed through importance pruning, which reduces the quantity of shapes per volume. By lowering the density of shapes for distant areas, the system can manage memory usage more efficiently. For example, when a user is standing near the center of the ballroom, the system can load a high-density set of shapes for a nearby chandelier while using a simplified, lower-density set for the far walls. The system may define two levels of detail for each chunk, though three or more levels can be used to manage complexity across various distances without exceeding memory limits.

A render of the ballroom is created from a first camera perspective by identifying the chunks closest to the viewpoint. For these nearby chunks, the system selects a first level of detail with a high density of shapes to capture fine details of the interior. For chunks that are farther away, such as a distant corner of the ballroom, the system selects a second level with a lower density of shapes. If the camera moves to a second perspective at a different location in the ballroom, the system updates the selection based on the new distances. Regions that were once far away and rendered with lower detail may now be rendered with the highest level of detail as the camera approaches. This selection process is based on established distance thresholds, ensuring that the appropriate set of shapes is loaded to optimize memory and rendering speed without losing visual quality.

In the context of a digital ballroom, the opacity blending scheme can manage the transition as a camera moves from one spatial chunk to another, such as moving from a dance floor area toward a seating area. To maintain visual consistency, the system can identify the two regions with centers closest to the current camera position and combine the sets of shapes associated with those regions. This combination ensures that the environment remains detailed while the system prepares to shift the primary rendering focus.

As the camera approaches the border between these two areas, the highest-level detail shapes, which contain the greatest density of fine features like the intricate textures on ballroom walls or the delicate parts of a chandelier, are faded in by modulating their transparency. Specifically, the system can identify the additional detail shapes that are unique to the high-density representation of the entering region. The opacity of these unique shapes can be gradually increased from 0% to 100% based on the location of the camera relative to the centers of the identified regions.

In some examples, this blending process works by calculating an interpolation factor based on the camera's position along a path between the centers of the two regions. As the camera moves toward the border and into the next region, the transparency of the high-detail shapes for the approaching area can be decreased, causing them to resolve smoothly over the existing geometry. Simultaneously, the unique shapes from the retreating area can have their transparency increased until they are fully faded out. This mechanism may prevent visual popping or sudden shifts in clarity at the border, allowing the highest resolution features to blend seamlessly into the scene as the camera changes perspective.

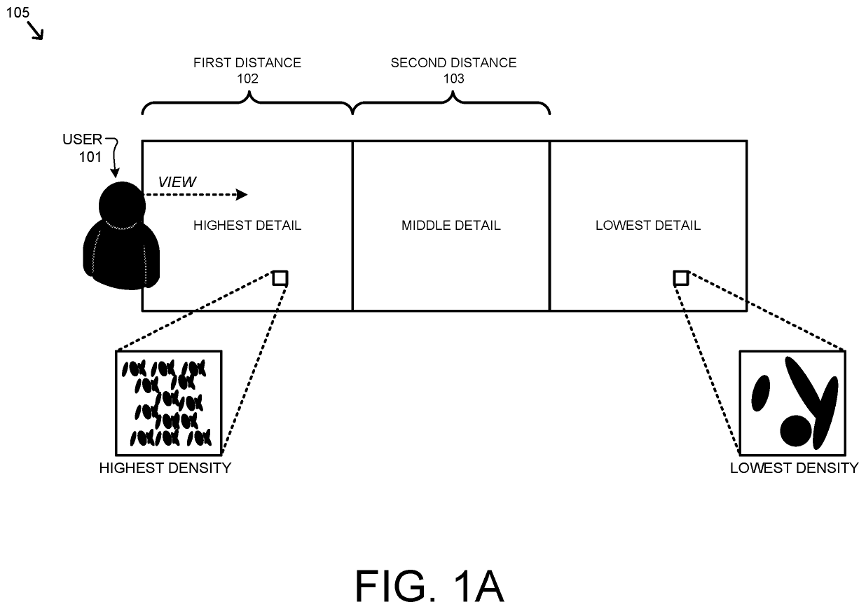

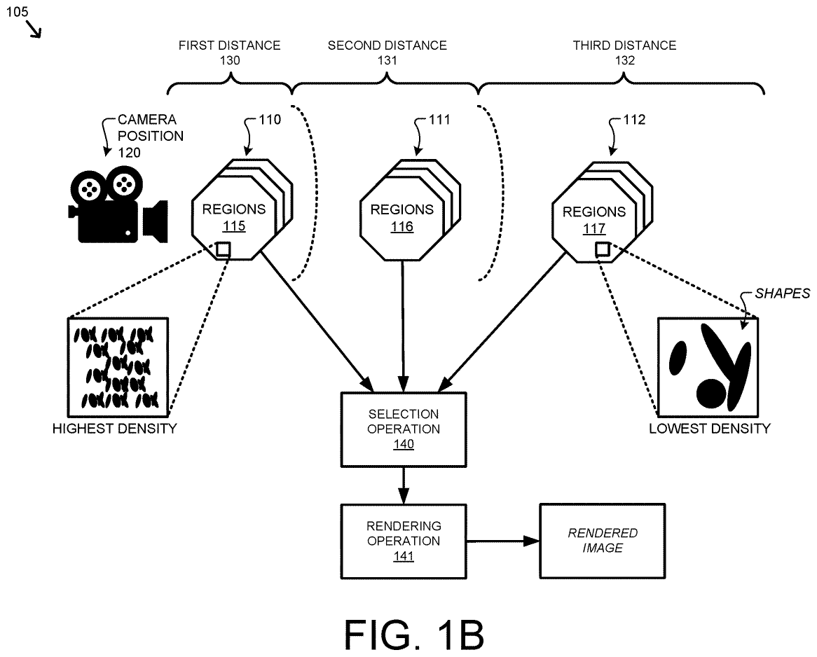

FIG. 1A illustrates an example of providing different levels of detail to a user according to an implementation. FIG. 1A includes user 101, first distance 102, and second distance 103. The example demonstrates the different levels of detail associated with the different distances. For instance, as user 101 navigates a digital environment, the system may provide a first level of detail for objects within first distance 102 and a second level of detail for objects within second distance 103. This configuration can enable a device to prioritize processing resources for the most relevant visual information based on the proximity of user 101 to various regions.

As an example, when user 101 views a digital representation of a park, a nearby tree within the first distance 102 may be rendered using a high density of shapes to show individual leaves and bark textures. At the same time, a distant fountain located outside of second distance 103 may be rendered using a lower density of shapes to show the general form and color of the structure. As the user 101 moves closer to the fountain, the system can dynamically increase the density of shapes for the fountain while decreasing the detail for the tree that is now further away. This approach can ensure a realistic experience while maintaining efficient performance on a mobile or wearable device.

FIG. 1B illustrates an operational scenario 105 of rendering an image of a scene according to an implementation. Operational scenario 105 includes first level of detail 110 with regions 115, a second level of detail 111 with regions 116, and a third level of detail 112 with regions 117. Operational scenario 105 further includes camera position 120, first distance 130, second distance 131, third distance 132, selection operation 140, and rendering operation 141. Operational scenario 105 can be performed by one or more computing devices, such as end-user devices (e.g., smartphones, wearables, etc.), laptop computers, desktop computers, servers, and the like. In some examples, at least a portion of the operations can be distributed across a cloud computing system (or other computing system) and a user device (e.g., a wearable device).

In operational scenario 105, a request is generated to render a scene from camera position 120. In response to the selection, selection operation 140 is performed that selects regions from levels of details 110, 111, and 112. In some implementations, selection operation 140 determines the appropriate level of detail to provide based on the proximity to camera position 120. In this configuration, the levels of detail represent different quantities of shapes per volume, where a higher-level number indicates a decreasing density of shapes used to represent the environment. For example, first level of detail 110 possesses a higher density than second level of detail 111 and third level of detail 112. This higher density allows first level of detail 110 to capture the finest geometric and visual features of the scene.

As illustrated in operational scenario 105, selection operation 140 identifies regions 115 from first level of detail 110 because they are located within first distance 130, which is the closest threshold to camera position 120. Regions 116 are selected from second level of detail 111 because they are located within second distance 131 (and outside of first distance 130), and regions 117 are selected from third level of detail 112 because they are located within third distance 132 (and outside of first distance 130 and second distance 131). Because the density of shapes is reduced in second level of detail 111 and third level of detail 112, the system can render distant parts of the scene with fewer computational resources. Rendering operation 141 then combines the shapes from these varying levels of detail to generate the final image. As the camera moves and the distance to different regions changes, the system can dynamically update the selection to maintain high-density shapes near the viewpoint while using lower-density shapes for faraway areas.

In some implementations, once selection operation 140 has identified the appropriate regions 115, 116, and 117 from the various levels of detail 110, 111, and 112, operational scenario 105 may process these shapes through a splatting technique as part of rendering operation 141. During this process, the 3D shapes from the combined levels are projected onto a 2D image plane corresponding to the viewpoint of camera position 120. For each pixel or tile within the 2D plane, the system can calculate the contribution of each shape based on attributes such as position, color, and opacity. Because the quantity of shapes per volume is lower for regions 117 at third distance 132 compared to regions 115 at first distance 130, the rendering operation can be executed more efficiently by processing fewer primitives for distant areas. To maintain visual continuity as a camera moves between regions, an opacity blending scheme may be applied to the shapes. This scheme can gradually adjust the transparency of shapes that are unique to specific chunks or regions, allowing for a smooth transition that may prevent visual artifacts. This approach allows operational scenario 105 to generate a high-quality image while managing the memory and computational load on the processing system.

In some examples, the system can be configured to identify two or more regions nearest to the current camera position and combine the sets of shapes associated with those regions. This operation may be performed to ensure a smooth transition and prevent visual artifacts, such as popping, as the camera moves between different parts of the scene. To achieve this, the system can apply an opacity blending scheme to the combined sets of shapes. In this configuration, the opacity of shapes that are unique to one of the identified regions may be modulated based on the location of the camera relative to the centers of those regions. For instance, as the camera moves toward a new region, the transparency of the shapes from that region can be gradually decreased to blend the different levels of detail together seamlessly and maintain visual consistency across the environment.

As an illustrative example of operational scenario 105, a computing environment may be used to generate an image of a room by organizing a 3D model into a hierarchical level-of-detail representation. In this scenario, the room is divided into spatial regions. The system identifies camera position 120 and determines the distances to the various regions to perform selection operation 140. For regions 115 located within first distance 130, first level of detail 110 is selected, which contains a high quantity of shapes per volume to provide a high-resolution view of the interior and furniture. For regions 116 located within second distance 131, the system selects second level of detail 111, which has a reduced density of shapes. For the most distant areas, such as regions 117 within third distance 132, third level of detail 112 is selected, featuring the lowest quantity of shapes per volume. Once the appropriate levels are selected for each region, rendering operation 141 can combine the shapes from levels of detail 110, 111, and 112 to generate a cohesive image. This allows the computing environment to maintain high visual quality for objects near the viewer while reducing the memory and computational load for distant parts of the room.

Although demonstrated in operational scenario 105 using three levels of detail, any number of levels of detail may be used to improve rendering efficiency. While three levels provide a balance between performance and visual fidelity, the system can be configured to generate additional levels for highly complex or expansive environments. Each added level may further reduce the number of shapes per unit volume as the distance from the camera increases, allowing the system to scale the model to meet the specific memory constraints of a device. By using more levels, the system can achieve a more granular transition between high-and low-density regions, potentially further optimizing computational load during real-time navigation.

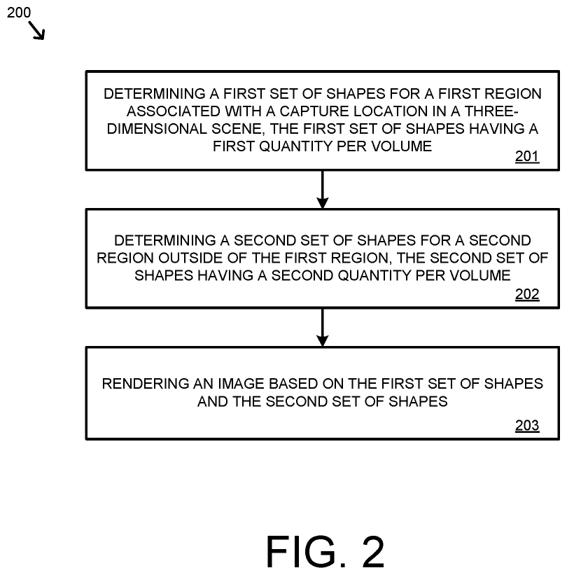

FIG. 2 illustrates a method 200 of rendering an image of a scene according to an implementation. Method 200 can be performed by one or more computing devices, including server computers and user devices (e.g., smartphones, tablets, wearable devices, and the like).

Method 200 includes determining a first set of shapes for a first region associated with a capture location (or position), the first set of shapes having a first quantity per volume at step 201. Method 200 further includes determining a second set of shapes for a second region outside of the first region, the second set of shapes having a second quantity per volume at step 202. Method 200 also provides for rendering an image based on the first set of shapes and the second set of shapes at step 203.

In some implementations, determining the first set of shapes for the first region associated with the capture location at step 201 can include selecting a specific subset of primitives, such as Gaussians, that provide a high level of detail for a volume near a camera position. The capture location can represent a current viewpoint or a requested camera pose in the 3D scene. To ensure a high visual fidelity, this first set of shapes can have a first quantity per unit volume, or population density, sufficient to represent detailed geometry and textures without causing aliasing. In some configurations, the first set of shapes may be selected from a plurality of potential sets of shapes based on the proximity of the capture location to a center or near center of the first region.

Determining the second set of shapes for the second region outside of the first region at step 202 can involve identifying a region that is further from the capture location and selecting a corresponding set of shapes that has a second quantity per volume. The second quantity per volume may be less than the first quantity per volume, representing a reduced level of detail. This reduction can be achieved by applying a 3D smoothing filter to a base set of shapes at a depth threshold corresponding to the distance of the second region. The smoothing filter can identify redundant shapes that are smaller than a sampling interval of a display, such as a threshold defined by Nyquist's theorem. These redundant shapes can then be removed through importance pruning to decrease the memory footprint and computational overhead for distant areas.

Rendering the image based on the first set of shapes and the second set of shapes at step 203 can involve a splatting process where the 3D shapes are projected onto a 2D image plane. Each shape can contribute a splat of color and opacity to the pixels it overlaps. To prevent visual artifacts or popping during transitions, an opacity blending scheme can be applied to modulate the transparency of the shapes based on the capture location relative to different regions. This rendering operation may further include determining an additional set of shapes for an additional region located even further from the capture location, where the additional set of shapes possesses a lower quantity per volume than the second set of shapes. This hierarchical structure allows the system to manage memory limits while maintaining a cohesive and realistic representation of the environment.

In some implementations, the system may utilize a plurality of potential shape sets for each region to facilitate hierarchical level-of-detail representation. This plurality can include different versions of shapes within a single spatial region, where each set is precomputed to meet a specific visual fidelity threshold based on distance. For example, a single region can be associated with a first potential set with a high quantity per unit volume for close-up viewing, a second potential set with a reduced quantity per unit volume for intermediate distances, and a third potential set with the lowest quantity per unit volume for far-away viewing.

The selection of a specific set from the plurality of potential sets of shapes can be determined dynamically based on the location of a region relative to the capture location. As the distance between the capture location and the center of a region changes, the system can switch between these pre-computed sets. For instance, when a region is within a first distance threshold, the system may select the highest-density set from the plurality of potential sets. If the capture location moves further away, exceeding a second distance threshold, the system can instead select a lower-density set for that same region. This multi-set configuration for each region allows the system to maintain a granular level of detail across the entire environment, ensuring that each part of the scene uses an optimal number of shapes for its current distance from the viewpoint. This may prevent the device from loading excessive data for distant areas while ensuring nearby objects remain highly detailed.

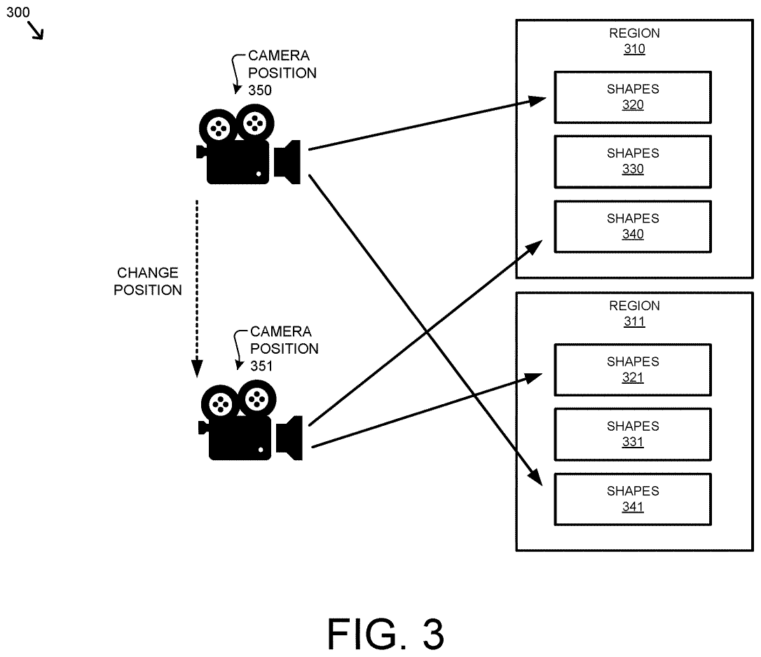

FIG. 3 illustrates an operational scenario 300 of rendering a scene from multiple images according to an implementation. Operational scenario 300 includes regions 310 and 311, wherein each region includes three different levels of detail. The highest level of detail for each region in regions 310 and 311 corresponds to shapes 320 and 321. A lower level of detail for each of the regions in regions 310 and 311 corresponds to shapes 330 and 331. The lowest level of detail for each of the regions in regions 310 and 311 corresponds to shapes 340 and 341. Operational scenario 300 further includes first camera position 350 and second camera position 351. Operational scenario 300 can be performed by one or more computing devices as part of a computing system, including server computers, desktop computers, user computing devices (e.g., smartphones, wearables, etc.), or other computing devices.

In operational scenario 300, a 3D scene can be generated using a set of shapes by first analyzing multiple input images to estimate camera positions and the depth of various surfaces, which allows for the placement of a dense collection of shapes or primitives in a 3D space. These shapes, which may include colored, semi-transparent 3D points such as Gaussians, are assigned specific attributes like position, size, color, and opacity. To create this initial 3D representation, the system can perform an optimization phase where the set of semi-transparent, colored 3D points is adjusted to match the appearance of the input images from various viewpoints. These shapes can be refined through a feedback loop that compares a rendered image to the source photographs to calculate a difference between the two. Based on this difference, the system may update the position, opacity, and scale of each primitive. This training cycle can continue until the collection of shapes accurately represents the fine geometric and visual details of the environment.

To manage this environment efficiently, a hierarchical level-of-detail representation can be created through an iterative pre-processing phase that occurs before rendering. During this phase, the 3D space is partitioned into spatial chunks, such as regions 310 and 311, using a clustering algorithm like K-means to group locations based on proximity to a centroid. For each region, the system establishes different levels of detail by applying a 3D smoothing filter based on a sampling interval, such as a threshold defined by Nyquist's theorem. This filter identifies shapes that are too small to be rendered clearly from a certain distance, allowing the system to perform importance pruning to remove redundant elements. This iterative refinement results in the highest level of detail for regions 310 and 311, represented by shapes 320 and 321, which possess the maximum quantity per volume to capture fine geometric features. Lower levels of detail, such as those corresponding to shapes 330, 331, 340, and 341, are subsequently generated with a reduced density of shapes to optimize memory and rendering speed for distant areas of the environment.

For first camera position 350, the system can identify regions 310 and 311 and determine their distance from the viewpoint. Based on established distance thresholds, the system may select the highest level of detail, represented by shapes 320, for region 310 because it is located closest to the camera. For region 311, which is further away, the system may select a lower level of detail, such as shapes 341, to reduce the quantity of shapes per volume. This selection process ensures that the most detailed primitives (i.e., shapes) are used for nearby objects while distant areas are represented with a lower population density to manage memory and computational load.

The final image may be rendered using a splatting process where the selected shapes from both levels of detail are projected onto a two-dimensional image plane. Projecting can involve mapping the three-dimensional coordinates of each shape, such as a Gaussian, to a specific pixel or tile on a user display. The system can then blend these semi-transparent 3D shapes based on their position, color, and opacity. During this blending operation, each shape may contribute a soft, elliptical color value to the pixels it overlaps, allowing the system to produce a realistic and cohesive view of the environment without requiring explicit geometry like a mesh. By using varying levels of detail, the system can prioritize computational resources for shapes near the capture location while efficiently processing simplified shapes in distant areas. To maintain visual continuity as the camera moves, an opacity blending scheme may be applied to gradually adjust the transparency of shapes when transitioning between regions. This technique can prevent visual artifacts and ensure that the various levels of detail fade together seamlessly to create a realistic representation of the scene.

In some implementations, the position of the camera can move within the 3D scene, such as moving from first camera position 350 to second camera position 351. In this configuration for second camera position 351, the system can dynamically update the selection of shapes to reflect the new proximity. For region 311, the system may transition from the lowest level of detail, shapes 341, to the highest level of detail, shapes 321. This selection provides a high quantity of shapes per volume for region 311, ensuring that the visual features now closest to the viewpoint are rendered with maximum fidelity. Conversely, as region 310 becomes more distant from second camera position 351, the system may select a lower level of detail, such as shapes 330 or 340, to reduce the density of shapes and optimize rendering performance.

In some implementations, a system can be configured to identify two or more regions nearest to the current camera position and combine the sets of shapes associated with those regions to provide the highest level of detail. This selection process ensures that the area surrounding the camera, as well as the area toward which the camera may be moving, is represented with the maximum quantity of shapes per volume. By loading the most detailed sets for multiple nearby regions, the system can maintain high visual fidelity and prevent visual artifacts, such as popping, which can occur if the level of detail changes abruptly when crossing a boundary.

For example, when navigating a digital reconstruction of a venue, the system may identify the two spatial chunks whose centers are closest to the camera position. If a viewer is standing near the transition point between a foyer region and a main hall region, the system can load the high-density sets of shapes for both regions simultaneously. To ensure a seamless experience, an opacity blending scheme can be applied where the transparency of shapes unique to the entering region is gradually decreased while the transparency of shapes unique to the exiting region is gradually increased. In another example, a system may be configured to load the highest level of detail for three regions if the camera is positioned at a junction where three spatial chunks meet. This configuration ensures that immediately adjacent areas are rendered with maximum detail, allowing for smooth transitions regardless of the direction the camera moves.

The loading and selection of these shapes are dynamically updated based on the current position of the camera relative to the pre-computed spatial chunks or regions. As the camera moves through the environment, the system determines the distances to the centers of the various regions. When the camera approaches a new region, the system can trigger the loading of the corresponding high-density set of shapes while transitioning distant regions to lower levels of detail with a reduced quantity of shapes per volume. This hierarchical management allows the system to prioritize computational resources for the most visible parts of the scene, ensuring real-time performance on devices with limited memory.

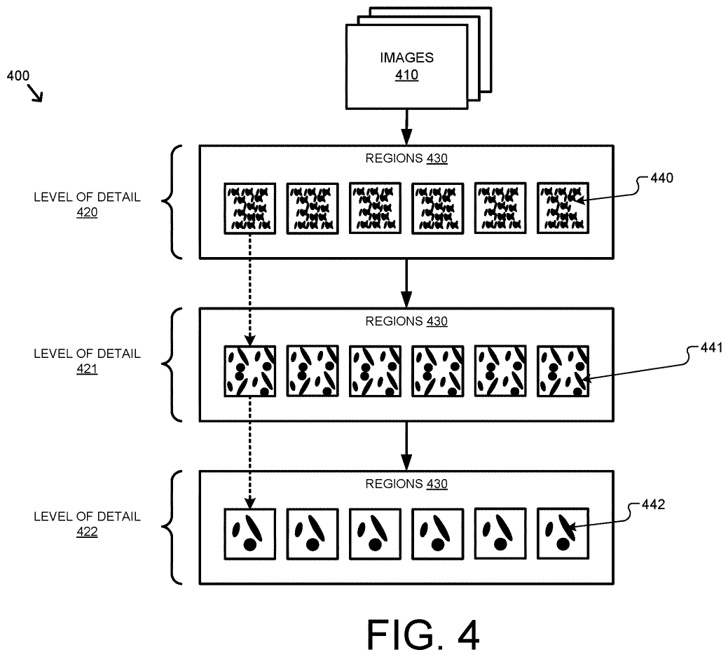

FIG. 4 illustrates an operational scenario 400 of generating different levels of detail for different regions according to an implementation. Operational scenario 400 includes images 410, level of detail 420 with regions 430 and shapes 440, second level of detail 421 with regions 430 and shapes 441, and level of detail 422 with regions 430 and shapes 442.

Operational scenario 400 illustrates the generation of a level-of-detail representation for a three-dimensional environment using images 410 as a source. The process begins by analyzing images 410 to estimate camera positions and the depth of various surfaces within a scene. Based on this data, a computing system generates a dense collection of shapes or primitives, such as semi-transparent 3D points, to reconstruct the environment. This initial set of shapes forms the basis for the highest level of detail 420, which is used to represent areas of the scene located closest to a camera viewpoint.

To manage the complexity of the scene, the 3D space is partitioned into manageable sections known as regions 430. These regions 430, also referred to as spatial chunks, can be determined through a mathematical grouping process like K-means clustering. In this process, various data points, such as the original camera positions from images 410 or synthetic viewpoints, are grouped into clusters based on their proximity to a central point. Each region 430 then acts as a local container for a specific subset of shapes, allowing the system to load and unload data efficiently based on the location of the viewer.

Within each of these regions 430, the system generates different levels of detail by establishing distance thresholds. The first level of detail 420 contains a first set of shapes 440 with a high quantity per volume. This high population density is designed to capture the finest visual and geometric features, ensuring that objects appear realistic and detailed when viewed from a close distance. This first level of detail 420 serves as the reference from which subsequent, less complex levels are derived.

The generation of the second level of detail 421 can include reducing the complexity of the shapes 440 found in the first level. To achieve this, the system can be configured to apply a 3D smoothing filter to the initial set of shapes. This filter can be based on Nyquist's theorem, which is a principle used to identify which parts of a signal are too small to be seen clearly at a certain sampling interval. If a shape is smaller than what can be clearly rendered on a screen from a specific distance, it can be considered redundant. By identifying these redundant elements, the system can determine a second set of shapes 441 for the second level of detail 421.

Once the redundant shapes are identified, the system can perform importance pruning to remove them. This reduces the quantity of shapes per volume for regions 430 at the second level of detail 421. As a result, shapes 441 are less dense than shapes 440, allowing the system to save memory and processing power when rendering parts of the scene that are further away. This hierarchical structure ensures that the device does not waste resources on fine details that would not be visible to the user at a distance.

Further levels of detail, such as level of detail 422, can be generated by continuing this process for even greater distances. For level of detail 422, a stronger smoothing filter may be applied to reflect a larger distance threshold. This identifies an even greater number of redundant shapes, which are then pruned to create a third set of shapes 442. This set possesses the lowest quantity per volume among the illustrated levels. By having multiple levels such as 420, 421, and 422, the system can provide a granular transition between high-and low-density areas.

This entire level-of-detail representation can be pre-computed before any rendering begins. By predetermining these levels, the system ensures that an end-user device, such as a smartphone or wearable, does not need to perform heavy calculations to decide which shapes to display in each frame. Instead, the device can identify the distance to each region 430 and select the appropriate set of shapes 440, 441, or 442. This strategy enables real-time navigation of large and complex digital environments without exceeding the memory limits of the hardware.

During a rendering operation, the selected shapes from the different levels are combined and projected onto a two-dimensional screen. To ensure the transition between different levels of detail and different regions 430 is smooth, the system may employ an opacity blending scheme. This technique can gradually adjust the transparency of the shapes as a viewer moves through the scene, preventing objects from suddenly appearing or disappearing. This combination of pre-computed levels of detail and smooth blending allows for a high-quality visual experience that is both efficient and realistic.

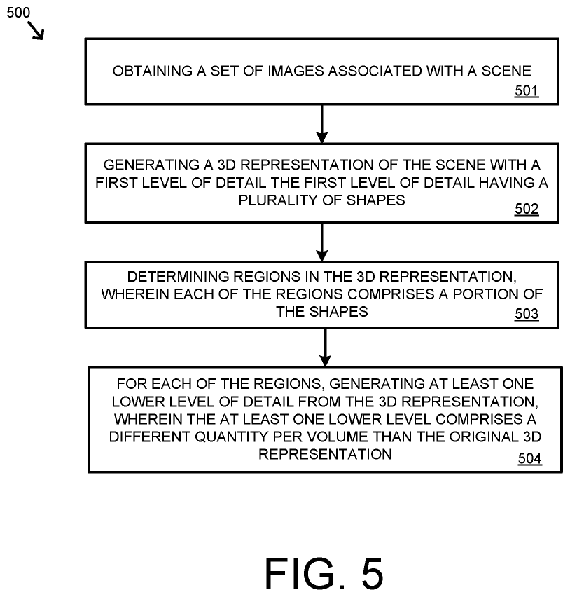

FIG. 5 illustrates a method 500 of generating different levels of detail for a scene according to an implementation. Method 500 can be performed by one or more computing devices, such as server computers, desktop computers, or other computing devices.

Method 500 includes obtaining a set of images associated with a scene at step 501 and generating a 3D representation of the scene with a first level of detail, the first level of detail having a plurality shapes at step 502. Method 500 further includes determining regions in the 3D representation, wherein each of the regions comprises a portion of the shapes at step 503. Once separated into regions, method 500 further provides, for each of the regions and at step 504, generating at least one lower level of detail from the 3D representation, wherein the at least one lower level comprises a different quantity per volume than the original 3D representation.

In some implementations, generating a 3D representation for method 500 can be initiated by obtaining a set of images of a scene. These images can be analyzed to estimate camera positions and the depth of various surfaces. In some implementations, the system may capture a scene from multiple viewpoints to ensure a comprehensive 3D reconstruction. For example, a room can be photographed from several different angles to identify the spatial layout and fine details of the environment. The resulting images may then be used to generate a collection of primitives, such as semi-transparent 3D points, which represent the geometry and appearance of the scene. These original images serve as the source data for determining the initial density of the 3D representation and establishing the first level of detail. Based on this data, a computing system can place a collection of primitives (i.e., shapes), such as Gaussians, in a 3D space to reconstruct the environment. These Gaussians can function as colored, semi-transparent 3D points, each possessing attributes such as position, size, color, and opacity. This initial optimization process creates a first level of detail that serves as a high-density reference for the scene. In some implementations, the 3D Gaussian splatting process includes an optimization phase where a set of semi-transparent, colored 3D points are adjusted to match the appearance of input images from various viewpoints. These shapes are iteratively refined through a feedback loop that compares a rendered image to the source photographs, calculating the difference between the two to update the position, opacity, and scale of each primitive. This training cycle continues until the collection of shapes accurately represents the fine geometric and visual details of the environment.

To manage the complexity of the environment, the 3D representation can be partitioned into distinct spatial regions, often referred to as chunks. In some implementations, the size of the regions may be determined through a spatial partitioning process that divides the environment into manageable sections. For example, to generate the 3D representation, the system can be configured to perform K-means clustering on the data points associated with the initial scene reconstruction. In this process, the original camera positions from the source images can be used as the basis for the clusters, grouping these locations into distinct neighborhoods based on their proximity to a calculated centroid. This ensures that each region corresponds to areas of the scene with high-value visual data. Each resulting cluster defines the spatial boundaries of a region, which then functions as a container for a specific portion of the shapes. This division may also incorporate synthetic viewpoints or random orientations to ensure the regions effectively cover the entire 3D space. Once the regions are established, a fixed set of shapes can be pre-assigned to each one, allowing the system to load and manage the complexity of the scene based on the distance between the camera and the center of each region.

For each of these regions, at least one lower level of detail can be generated to reduce the quantity of shapes per volume compared to the original 3D representation. This process may involve applying a 3D smoothing filter to the initial set of shapes. The filter can be configured according to Nyquist's theorem, a mathematical principle used to identify signal components that are too small to be reconstructed at a given sampling interval. If a shape is smaller than the pixel sampling interval on a display at a given viewing distance, the shape can be considered redundant. This display size can be indicated as a parameter for generating the different levels of detail.

Once redundant shapes are identified within a region, the system can perform importance pruning to remove them. This reduction in the population density of shapes ensures that distant areas contribute less to the computational load while maintaining visual fidelity. By pre-computing these lower levels of detail, the system can create a hierarchical representation that can be loaded dynamically. This allows the device to avoid heavy computation of active shapes during each frame of a rendering operation.

During the generation of an image, the system can identify the regions nearest to a current capture location and select the appropriate level of detail based on distance thresholds. For regions located near the camera, the first level of detail with a high quantity of shapes can be utilized. For regions located further away, the system can select the pre-computed lower levels of detail with a reduced quantity of shapes per volume. These shapes can then be projected onto a 2D image plane and blended together through a process known as splatting.

To ensure visual consistency and prevent artifacts such as popping as a camera moves between regions, an opacity blending scheme can be applied. This scheme may involve identifying the two regions closest to the camera position and combining their active sets of shapes. The transparency of shapes that are unique to one of the regions can then be modulated based on the camera's location relative to the centers of the regions. This allows different levels of detail to fade together seamlessly, maintaining a realistic representation of the environment even as the density of shapes changes across the 3D space.

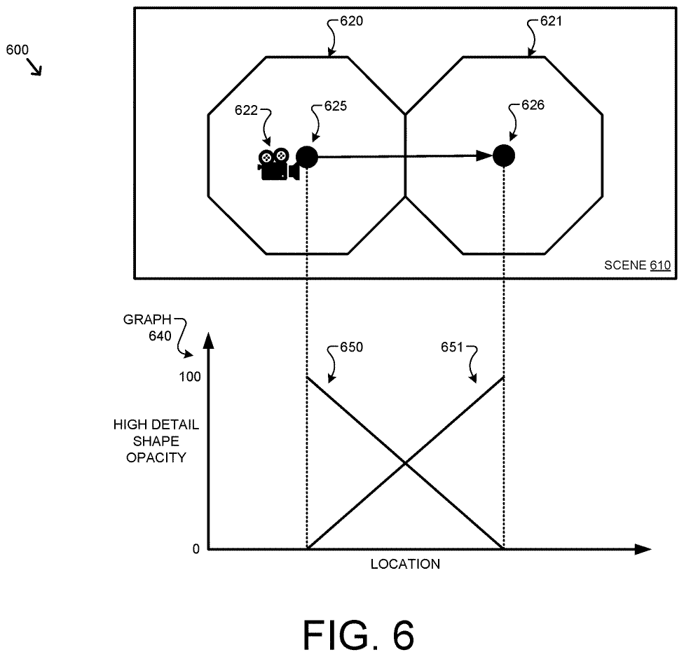

FIG. 6 illustrates an operational scenario 600 of performing blending between regions according to an implementation. Operational scenario 600 includes 3D scene 610 with region 620, region 621, camera 622, camera position 625, and camera position 626. Operational scenario 600 further includes graph 640 that demonstrates the transition as camera 622 moves from camera position 625 to camera position 626. Graph 640 includes lines 650-651 that represent the opacity of the highest level of detail for region 620 (line 650) and region 621 (line 651).

In operational scenario 600, camera 622, which can be a virtual camera capturing 3D scene 610, transitions from region 620 to region 621. As camera 622 moves toward the center of region 621, the system transitions the level of detail to ensure that the visual features closest to the viewpoint are rendered with maximum fidelity. Initially, when the camera is positioned at a distance, such as at camera position 625, region 621 may be represented using a lower level of detail. This lower level of detail, represented by line 651 in graph 640, contains a second set of shapes with a lower quantity per volume. This reduction in density can be achieved during a pre-processing phase by applying a 3D smoothing filter based on a sampling interval, which identifies redundant shapes for removal through importance pruning.

As camera 622 approaches region 621, the system can be configured to proactively update the selection of active shapes to reflect the new proximity. This transition involves moving from a lower level of detail to the highest level of detail for region 621, represented by line 651 (i.e., the increase in high detail shape opacity). The highest level of detail contains a first set of shapes with a higher quantity per volume to capture fine geometric and visual features. To manage this transition smoothly, the system can identify region 621 and an adjacent region, such as region 620, as the two spatial chunks nearest to camera 622 and combine their highest density sets of shapes into a single active set.

The system can facilitate a seamless transition from the lower level of detail to the higher level of detail by employing an opacity blending scheme. In this configuration, the system identifies the additional details, the shapes unique to the high-density representation of region 621 that are not present in the lower-detail version or the adjacent region. As camera 622 moves from camera position 625 toward camera position 626, the opacity of these unique, high-detail shapes is modulated based on the location of the camera relative to the centers of the regions. Specifically, the opacity of the additional details for region 621 can be gradually increased from 0% to 100%.

For example, if region 621 contains a fireplace, the fireplace may initially be rendered using a pruned set of shapes that provide the general form and color from a distance. As camera 622 moves toward the fireplace, the system identifies that the fireplace region is one of the two nearest regions and triggers the loading of the highest level of detail. The system then calculates an interpolation factor by projecting the camera position onto the line connecting the centers of region 620 and region 621. This factor determines the progressive fade of the additional details, such as the texture of the brick or the edges of the grate, ensuring they resolve smoothly over the baseline geometry.

This transition logic ensures that by the time camera 622 reaches the center of region 621 at camera position 626, the additional details are fully opaque and the region is rendered with maximum detail. Because the foundational shapes were already present in the lower-detail version, the user may perceive the environment as sharpening rather than popping into view. The system can then retire the more distant region 620 from the high-detail slot (demonstrated as line 650), allowing the device to maintain real-time performance by prioritizing memory and computational resources for the most visible parts of the 3D scene.

In some configurations, the system may identify three or more regions nearest to the capture location and combine the high-density sets of shapes for each of these regions. For example, if the capture location is situated at a junction where multiple spatial chunks converge, the system can load the highest level of detail for all adjacent regions simultaneously. This ensures that the immediate environment around the camera is represented with the maximum quantity of shapes per volume, regardless of the specific direction of travel. By maintaining high-density data for all potential paths, the system can preserve visual fidelity and ensure the rendering remains consistent as the viewpoint shifts between multiple intersecting boundaries.

To handle movement in scenarios involving multiple dense regions, the system can apply the opacity blending scheme to the unique shapes of each entering and exiting region. The transparency of shapes unique to a new region can be gradually increased as the camera moves toward the center of that region, while the transparency of shapes unique to a retreating region can be gradually decreased. This modulation may be based on the location of the camera relative to the centers of all identified nearby regions. This approach can function similarly to the two-region example, utilizing interpolation factors to ensure that additional geometric and visual details resolve or fade smoothly. This hierarchical management allows the system to prioritize computational resources for the most visible areas, facilitating real-time navigation of complex scenes on devices with limited memory.

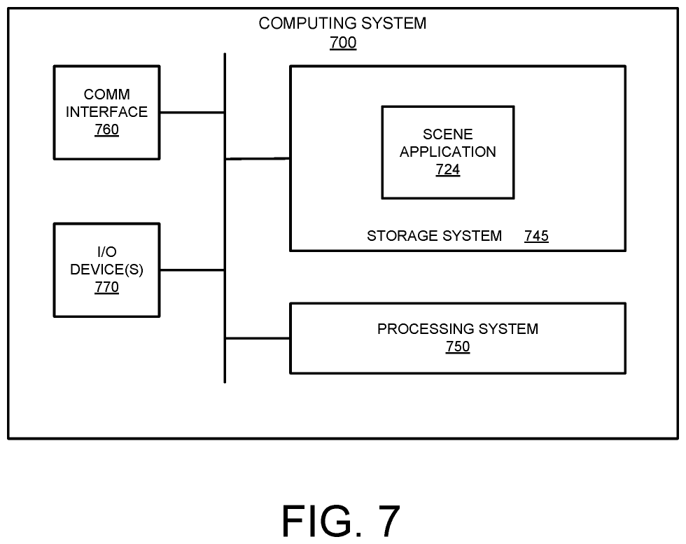

FIG. 7 illustrates a computing system 700 to display a 3D scene according to an implementation. Computing system 700 is representative of any computing system or systems with which the various operational architectures, processes, scenarios, and sequences disclosed herein can be implemented to generate and render a 3D scene. Computing system 700 can include multiple computing devices in some examples, such as a computing device that generates the shapes for the scene and the computing device that renders the scene. Computing system 700 includes storage system 745, processing system 750, communication interface 760, and input/output (I/O) device(s) 770. Processing system 750 is operatively linked to communication interface 760, I/O device(s) 770, and storage system 745. In some implementations, communication interface 760 and/or I/O device(s) 770 may be communicatively linked to storage system 745. Computing system 700 may further include other components, such as a battery and enclosure, that are not shown for clarity.

Communication interface 760 comprises components that communicate over communication links, such as network cards, ports, radio frequency, processing circuitry and software, or some other communication devices. Communication interface 760 may be configured to communicate over metallic, wireless, or optical links. Communication interface 760 may be configured to use Time Division Multiplex (TDM), Internet Protocol (IP), Ethernet, optical networking, wireless protocols, communication signaling, or some other communication format, including combinations thereof. Communication interface 760 may be configured to communicate with external devices, such as servers, user devices, or some other computing device.

I/O device(s) 770 may include computer peripherals that facilitate the interaction between the user and computing system 700. Examples of I/O device(s) 770 may include keyboards, mice, trackpads, monitors, displays, printers, cameras, microphones, external storage devices, and the like.

Processing system 750 comprises microprocessor circuitry (e.g., at least one processor) and other circuitry that retrieves and executes operating software from storage system 745. Storage system 745 may include volatile and nonvolatile, removable, and non-removable media implemented in any method or technology for information storage, such as computer-readable instructions, data structures, program modules, or other data. Storage system 745 may be implemented as a single storage device, but may also be implemented across multiple storage devices or sub-systems. Storage system 745 may comprise additional elements, such as a controller to read operating software from the storage systems. Examples of storage media (also referred to as computer-readable storage media) include random access memory, read-only memory, magnetic disks, optical disks, and flash memory, as well as any combination or variation thereof or any other type of storage media. In some implementations, the storage media may be non-transitory. In some instances, at least a portion of the storage media may be transitory. In no case is the storage media a propagated signal.

Processing system 750 is typically mounted on a circuit board that may hold the storage system. The operating software of storage system 745 comprises computer programs, firmware, or another form of machine-readable program instructions. The operating software of storage system 745 comprises scene application 724. The operating software on storage system 745 may include an operating system, utilities, drivers, network interfaces, applications, or other types of software. When read and executed by processing system 750, the operating software on storage system 745 directs computing system 700 to operate as described in the previously described figures.

In at least one implementation, scene application 724 can, when executed by processing system 750, generate and render a three-dimensional representation of a scene using multiple levels of detail. The system can utilize a hierarchical representation where the complexity of the scene is adjusted based on a distance from a capture location. As a user navigates the environment, the processing system 750 can execute the scene application 724 to dynamically select and blend different sets of shapes to maintain high visual fidelity while managing memory and computational resources.

The different levels of detail can be pre-computed by applying a 3D smoothing filter to an initial set of shapes. This filter may be configured based on a sampling interval associated with a screen space. Shapes that are smaller than the sampling interval at a specific distance can be identified as redundant because they would not be clearly rendered on a display. Once these redundant shapes are identified, the system can perform importance pruning to remove them, resulting in a set of shapes with a lower quantity per volume (i.e., lower density). This process can be performed iteratively to create multiple levels of detail, where a higher quantity of shapes per volume is maintained for regions near the capture location and a lower quantity per volume is used for distant regions.

To facilitate efficient rendering, the system can divide the three-dimensional scene into spatial chunks or regions using a clustering algorithm like K-means clustering. Each region can act as a local container for the pre-computed sets of shapes. When rendering an image, the system can identify the regions nearest to the current capture location and select the appropriate level of detail for each region based on established distance thresholds. For example, if a camera approaches a specific feature like a fireplace, the fireplace may initially be rendered using a lower level of detail with a reduced quantity of shapes per volume. As the camera moves closer and the fireplace region becomes one of the nearest regions, the system can load the highest level of detail for that region.

Rendering can be performed using a splatting process where the selected 3D shapes are projected onto a 2D image plane. Each shape can contribute a splat of color and opacity to the pixels it overlaps. To prevent visual artifacts such as popping during transitions, an opacity blending scheme can be applied. In this configuration, the system can identify additional details, which are the shapes unique to the high-detail representation that are not present in the lower-detail version. As the camera moves toward the region, the transparency of these additional details can be gradually decreased from 0% to 100% based on the location of the camera relative to the centers of the regions. This logic ensures that high-density features resolve smoothly over the baseline geometry, providing a seamless visual experience.

Below are example clauses associated with the present disclosure. The described clauses should not be considered exhaustive.

Clause 1. A method comprising: determining a first set of shapes for a first region associated with a capture location in a three-dimensional scene, the first set of shapes having a first density; determining a second set of shapes for a second region outside of the first region, the second set of shapes having a second density; and rendering an image based on the first set of shapes and the second set of shapes.

Clause 2. The method of clause 1, wherein determining the first set of shapes for the first region associated with the capture location comprises: selecting the first set of shapes from a plurality of potential sets of shapes based on the capture location.

Clause 3. The method of clause 1, wherein determining the second set of shapes for the second region comprises: determining a location of the second region relative to the capture location; and selecting the second set of shapes from a plurality of potential sets of shapes based on the location of the second region relative to the capture location.

Clause 4. The method of clause 1, further comprising: determining an additional set of shapes for an additional region outside of the first region and the second region, the additional set of shapes having an additional density, wherein rendering the image is further based on the additional set of shapes.

Clause 5. The method of clause 4, wherein determining the additional set of shapes for the additional region comprises: determining a location of the additional region relative to the capture location; and selecting the additional set of shapes from a plurality of potential sets of shapes based on the location of the additional region relative to the capture location.

Clause 6. The method of clause 1 further comprising: identifying a second capture location in the three-dimensional scene, the second capture location outside of the first region; determining a different set of shapes for the first region based on the second capture location; and rendering a second image for the second capture location based on the different set of shapes for the first region.

Clause 7. The method of clause 6, wherein the second capture location is associated with the second region, and wherein the method further comprises: determining a different set of shapes for the second region based on the second capture location; wherein rendering the second image for the second capture location is further based on the different set of shapes for the second region.

Clause 8. A computer-readable storage medium having program instructions stored thereon that, when executed by at least one processor, direct the at least one processor to perform a method, the method comprising: determining a first set of shapes for a first region associated with a capture location in a three-dimensional scene, the first set of shapes having a first density; determining a second set of shapes for a second region outside of the first region, the second set of shapes having a second density; and rendering an image based on the first set of shapes and the second set of shapes.

Clause 9. The computer-readable storage medium of clause 8, wherein determining the first set of shapes for the first region associated with the capture location comprises: selecting the first set of shapes from a plurality of potential sets of shapes based on the capture location.

Clause 10. The computer-readable storage medium of clause 8, wherein determining the second set of shapes for the second region comprises: determining a location of the second region relative to the capture location; and selecting the second set of shapes from a plurality of potential sets of shapes based on the location of the second region relative to the capture location.

Clause 11. The computer-readable storage medium of clause 8, wherein the method further comprises: determining an additional set of shapes for an additional region outside of the first region and the second region, the additional set of shapes having an additional density, wherein rendering the image is further based on the additional set of shapes.

Clause 12. The computer-readable storage medium of clause 11, wherein determining the additional set of shapes for the additional region comprises: determining a location of the additional region relative to the capture location; and selecting the additional set of shapes from a plurality of potential sets of shapes based on the location of the additional region relative to the capture location.

Clause 13. The computer-readable storage medium of clause 8, wherein the first set of shapes and the second set of shapes comprise Gaussians.

Clause 14. The computer-readable storage medium of clause 8, wherein the second density is less than the first density.

Clause 15. A computing system comprising: a computer-readable storage medium; at least one processor operatively coupled to the computer-readable storage medium; and program instructions stored on the computer-readable storage medium that, when executed by the at least one processor, direct the computing system to perform a method, the method comprising: determining a first set of shapes for a first region associated with a capture location in a three-dimensional scene, the first set of shapes having a first density; determining a second set of shapes for a second region outside of the first region, the second set of shapes having a second density; and rendering an image based on the first set of shapes and the second set of shapes.

Clause 16. The computing system of clause 15, wherein determining the first set of shapes for the first region associated with the capture location comprises: selecting the first set of shapes from a plurality of potential sets of shapes based on the capture location.

Clause 17. The computing system of clause 15, wherein determining the second set of shapes for the second region comprises: determining a location of the second region relative to the capture location; and selecting the second set of shapes from a plurality of potential sets of shapes based on the location of the second region relative to the capture location.

Clause 18. The computing system of clause 15, wherein the method further comprises: determining an additional set of shapes for an additional region outside of the first region and the second region, the additional set of shapes having an additional density, wherein rendering the image is further based on the additional set of shapes.

Clause 19. The computing system of clause 18, wherein determining the additional set of shapes for the additional region comprises: determining a location of the additional region relative to the capture location; and selecting the additional set of shapes from a plurality of potential sets of shapes based on the location of the additional region relative to the capture location.

Clause 20. The computing system of clause 15, further comprising: identifying a second capture location in the three-dimensional scene; determining, for the first region, a first set of additional shapes based on the second capture location, the first set of additional shapes replacing the first set of shapes for the first region; determining, for the second region, a second set of additional shapes based on the second capture location, the second set of additional shapes replacing the second set of shapes for the second region; and rendering a second image based on the first set of additional shapes and the second set of additional shapes.

In accordance with aspects of the disclosure, implementations of various techniques and methods described herein may be implemented in digital electronic circuitry, or in computer hardware, firmware, software, or in combinations of them. Implementations may be implemented as a computer program product (e.g., a computer program tangibly embodied in an information carrier, a machine-readable storage device, a computer-readable medium, a tangible computer-readable medium), for processing by, or to control the operation of, data processing apparatus (e.g., a programmable processor, a computer, or multiple computers). In some implementations, a tangible computer-readable storage medium may be configured to store instructions that, when executed, cause a processor to perform a process. A computer program, such as the computer program(s) described above, may be written in any form of programming language, including compiled or interpreted languages, and may be deployed in any form, including as a standalone program or as a module, component, subroutine, or other unit suitable for use in a computing environment. A computer program may be deployed to be processed on one computer or on multiple computers at one site or distributed across multiple sites and interconnected by a communication network.

While certain features of the described implementations have been illustrated as described herein, many modifications, substitutions, changes, and equivalents will now occur to those skilled in the art. It is, therefore, to be understood that the appended claims are intended to cover all such modifications and changes as fall within the scope of the implementations. They have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components, and/or features of the different implementations described.

It will be understood that, in the foregoing description, when an element is referred to as being on, connected to, electrically connected to, coupled to, or electrically coupled to another element, it may be directly on, connected, or coupled to the other element, or one or more intervening elements may be present. In contrast, when an element is referred to as being directly on, directly connected to, or directly coupled to another element, there are no intervening elements present. Although the terms directly on, directly connected to, or directly coupled to may not be used throughout the detailed description, elements that are shown as being directly on, directly connected, or directly coupled can be referred to as such. The claims of the application, if any, may be amended to recite exemplary relationships described in the specification or shown in the figures.

As used in this specification, a singular form may, unless definitively indicating a particular case in terms of the context, include a plural form. Spatially relative terms (e.g., over, above, upper, under, beneath, below, lower, and so forth) are intended to encompass different orientations of the device in use or operation in addition to the orientation depicted in the figures. In some implementations, the relative terms above and below can, respectively, include vertically above and vertically below. In some implementations, the term adjacent can include laterally adjacent to or horizontally adjacent to.

What is claimed is:

1. A method comprising:
determining a first set of shapes for a first region associated with a capture location in a three-dimensional scene, the first set of shapes having a first density;
determining a second set of shapes for a second region outside of the first region, the second set of shapes having a second density; and
rendering an image based on the first set of shapes and the second set of shapes.

2. The method of claim 1, wherein determining the first set of shapes for the first region associated with the capture location comprises:
selecting the first set of shapes from a plurality of potential sets of shapes based on the capture location.

3. The method of claim 1, wherein determining the second set of shapes for the second region comprises:
determining a location of the second region relative to the capture location; and
selecting the second set of shapes from a plurality of potential sets of shapes based on the location of the second region relative to the capture location.

4. The method of claim 1, further comprising:
determining an additional set of shapes for an additional region outside of the first region and the second region, the additional set of shapes having an additional density,
wherein rendering the image is further based on the additional set of shapes.

5. The method of claim 4, wherein determining the additional set of shapes for the additional region comprises:
determining a location of the additional region relative to the capture location; and
selecting the additional set of shapes from a plurality of potential sets of shapes based on the location of the additional region relative to the capture location.

6. The method of claim 1 further comprising:
identifying a second capture location in the three-dimensional scene, the second capture location outside of the first region;
determining a different set of shapes for the first region based on the second capture location; and
rendering a second image for the second capture location based on the different set of shapes for the first region.

7. The method of claim 6, wherein the second capture location is associated with the second region, and wherein the method further comprises:
determining a different set of shapes for the second region based on the second capture location;
wherein rendering the second image for the second capture location is further based on the different set of shapes for the second region.

8. A computer-readable storage medium having program instructions stored thereon that, when executed by at least one processor, direct the at least one processor to perform a method, the method comprising:
determining a first set of shapes for a first region associated with a capture location in a three-dimensional scene, the first set of shapes having a first density;
determining a second set of shapes for a second region outside of the first region, the second set of shapes having a second density; and
rendering an image based on the first set of shapes and the second set of shapes.

9. The computer-readable storage medium of claim 8, wherein determining the first set of shapes for the first region associated with the capture location comprises:
selecting the first set of shapes from a plurality of potential sets of shapes based on the capture location.

10. The computer-readable storage medium of claim 8, wherein determining the second set of shapes for the second region comprises:
determining a location of the second region relative to the capture location; and
selecting the second set of shapes from a plurality of potential sets of shapes based on the location of the second region relative to the capture location.

11. The computer-readable storage medium of claim 8, wherein the method further comprises:
determining an additional set of shapes for an additional region outside of the first region and the second region, the additional set of shapes having an additional density,
wherein rendering the image is further based on the additional set of shapes.

12. The computer-readable storage medium of claim 11, wherein determining the additional set of shapes for the additional region comprises:
determining a location of the additional region relative to the capture location; and
selecting the additional set of shapes from a plurality of potential sets of shapes based on the location of the additional region relative to the capture location.

13. The computer-readable storage medium of claim 8, wherein the first set of shapes and the second set of shapes comprise Gaussians.

14. The computer-readable storage medium of claim 8, wherein the second density is less than the first density.

15. A computing system comprising:
a computer-readable storage medium;
at least one processor operatively coupled to the computer-readable storage medium; and
program instructions stored on the computer-readable storage medium that, when executed by the at least one processor, direct the computing system to perform a method, the method comprising:
determining a first set of shapes for a first region associated with a capture location in a three-dimensional scene, the first set of shapes having a first density;
determining a second set of shapes for a second region outside of the first region, the second set of shapes having a second density; and
rendering an image based on the first set of shapes and the second set of shapes.

16. The computing system of claim 15, wherein determining the first set of shapes for the first region associated with the capture location comprises:
selecting the first set of shapes from a plurality of potential sets of shapes based on the capture location.

17. The computing system of claim 15, wherein determining the second set of shapes for the second region comprises:
determining a location of the second region relative to the capture location; and
selecting the second set of shapes from a plurality of potential sets of shapes based on the location of the second region relative to the capture location.

18. The computing system of claim 15, wherein the method further comprises:
determining an additional set of shapes for an additional region outside of the first region and the second region, the additional set of shapes having an additional density,
wherein rendering the image is further based on the additional set of shapes.

19. The computing system of claim 18, wherein determining the additional set of shapes for the additional region comprises:
determining a location of the additional region relative to the capture location; and
selecting the additional set of shapes from a plurality of potential sets of shapes based on the location of the additional region relative to the capture location.

20. The computing system of claim 15, further comprising:
identifying a second capture location in the three-dimensional scene;
determining, for the first region, a first set of additional shapes based on the second capture location, the first set of additional shapes replacing the first set of shapes for the first region;
determining, for the second region, a second set of additional shapes based on the second capture location, the second set of additional shapes replacing the second set of shapes for the second region; and
rendering a second image based on the first set of additional shapes and the second set of additional shapes.
